(19) United States
(12) Patent Application Publication
(10) Pub. No.: US 2003/0215548 A1
(43) Pub. Date: Nov. 20, 2003

(54) Method of preparation of ice cream type products containing 0.5% to 40% by weight of ethylalcohol or alcoholic beverages

(76) Inventor: Stana Mihajlovic, Arlington, MA (US)

Correspondence Address: STANA MIHAJLOVIC, 140 PALMER ST, ARLINGTON, MA, 02474, US

(21) Appl. No.: 10/440,876

(22) Filed: May 17, 2003

Related U.S. Application Data
(60) Provisional application No. 60/381,716, filed on May 18, 2002.

(51) Int. Cl. A23G 9/00

(52) U.S. Cl. 426/101

(57) ABSTRACT

A method of preparation and composition of ice cream type products containing 0.5% to 40% by weight of ethyl alcohol or alcoholic beverages is presented. The ice cream type products include ice creams, sherbets and sorbets. When such products are prepared according to the method herein described their texture and structure remain stable and homogeneous and no separation of ethyl alcohol occurs after freezing and during storage of the frozen products.

This application claims the benefit of my previous provisional application # 60/381,716, filed on May 18^{th}, 2002.

### BACKGROUND—FIELD OF INVENTION

This invention relates to ice creams, sherbets and sorbets. This invention also relates to a method of preparation and a composition of ice cream, sherbet and sorbet products containing substantial amounts of alcoholic beverages or ethyl alcohol. This invention also relates to a method and composition of preparation of an ethyl alcohol stabilizing mix which, when admixed with basic ice cream type mixes results in finished ice cream type products with stable and homogeneous structure and texture after freezing and during storage with separation of the ethyl alcohol contained in these finished products.

When ethyl alcohol is used in compositions of ice cream, sherbet and sorbet products prepared using conventional methods of preparation, the resulting products do not retain a homogeneous and stable texture and structure after the freezing process is completed. The alcoholic beverage or ethyl alcohol will exude from the bulk of the frozen ice cream, sherbet and sorbet products and migrate to the bottom of the container where the mix is stored. The separation of the ethyl alcohol destroys the homogeneity of the texture and of the structure of the frozen products and creates an undesirable second phase at the bottom of the container, consisting mainly of ethyl alcohol.

This phenomenon occurs due to the freezing point of ethyl alcohol being lower than the freezing point of the other ingredients of ice creams, sherbets and sorbets. Thus, ethyl alcohol will not freeze with the remaining ingredients of an ice cream, sherbet or sorbet mix because its freezing point is not reached in conventional manufacturing conditions of ice cream type products. As a result, when the freezing of the ice cream type mix is completed, the ethyl alcohol will separate from the mass of the ice cream type product and accumulate on the bottom of the container in which the ice cream type product is stored. The freezing point of ethyl alcohol is −117.3° C., a temperature which, besides not being achievable in practical manufacturing methods, would render the resulting ice cream type products inedible.

Because of this problem, alcoholic beverages and ethyl alcohol have been very sparsely used as a flavoring component in concentrations higher than 0.5% in ice cream type products, despite the fact that alcoholic beverage flavors are very suitable for flavoring such products. Alcoholic beverages have only been used in ice creams, sherbets and sorbets in residual concentrations, generally originating from maceration of dried fruits to be added to the finished products. The resulting alcoholic concentration is usually lower than 0.25%. Marshall and Arbuckle's Ice Cream, 5th Edition, recommends using rum flavor and not the actual alcoholic beverage in a punch-flavored ice cream.

Restaurants and bars eventually prepare mixed alcoholic drinks based on alcoholic beverages and ice creams, sherbets or sorbets. The texture of such drinks resembles ice slush; such drinks are prepared on site for immediate consumption. Once the alcoholic beverage has been combined with the ice cream, sherbet or sorbet the resulting products become unstable and cannot be stored or transported, because the product will loose its consistency, texture and homogeneity.

Restaurants sometimes prepare alcoholic sorbets, usually flavored with white sparkling wine or liqueurs. Such sorbets are intended for immediate on site consumption; they are not stable and their structure resembles the one of slush, in which the ethyl alcohol separates from the bulk of the sorbet, leaving behind pieces of ice or frozen fruit juice.

U.S. Pat. No. 5,019,414 discloses a method for preparation of an alcoholic pipeable gel that can be piped over ice cream type products. Such gel, however, does not become an integral part of the ice cream type product. Such gel is not present in the ice cream type product during the freezing process. A mixing operation would have to be conducted at the time of the consumption of the ice cream product in order to integrate the gel with ice cream. Such procedure would alter the structure and texture of the ice cream type product.

European patent application # 87115386.2 claims a soft composition containing ethyl alcohol and supplied in pre-portioned packaging, which can be frozen at the consumption site, resulting in a product with the consistency and texture of a soft ice or slush. This product is also called a frozen drink in the patent. The product cannot be classified as an ice cream or a sherbet due to the absence of dairy products in its formulation and due to its texture. This product cannot be classified as a sorbet either, since the texture, as stated in the patent application text is similar to that of a slush.

European Patent application US2001041208 describes a method for stabilizing ethyl alcohol in ice creams by adding a blend of milk solids and stabilizers to the basic ice cream mix prior to the admixture of ethyl alcohol with the ice cream mix. The method described in this application does not address a direct stabilizing action on the ethyl alcohol by means of preparing an ethyl alcohol stabilizing mix prior to admixing the ethyl alcohol with basic ice cream type mixes. The method also precludes manufacturing of sorbets, due to the compulsory presence of milk solids in the stabilizing mix.

### SUMMARY OF THE INVENTION

This invention describes method and composition for preparing ice creams, sherbet and sorbets containing 0.5-40% of ethyl alcohol by weight. When ice creams, sherbets and sorbets are prepared using the method and composition herein described, the ethyl alcohol does not separate from the mass of the finished products and the texture and structure of the finished remain stable and homogeneous.

The novel and central aspect of this invention is the admixture of the ethyl alcohol with other ingredients of the ice cream type product while in the form of an ethyl alcohol stabilizing mix. Such ethyl alcohol stabilizing mix is prepared in advance and contains 0.5-95% of ethyl alcohol.

### DETAILED DESCRIPTION OF THE INVENTION

The present invention includes methods and compositions for the preparation of alcoholic ice cream, sherbet and sorbet products with stable and homogeneous texture and structure, by admixing ethyl alcohol stabilizing mixes with the basic ice cream, sherbet or sorbet mixes prior to freezing, and then freezing the resulting mix.

The method of admixing ethyl alcohol in the form of an ethyl alcohol stabilizing mix with the basic ice cream, sherbet or sorbet mix is the novel and main concept of the present invention and one that is not shown in teachings of the prior art.

The ethyl alcohol stabilizing mix comprises alcoholic beverages, ethyl alcohol, filtered water and hydrocolloids. The pre-treatment of the alcoholic beverage or ethyl alcohol in a solution with hydrocolloids results in an effective retention of the alcoholic beverage or ethyl alcohol in the bulk of the ice cream, sherbet or sorbet products during and after the freezing process, when this ethyl alcohol stabilizing mix is admixed with the basic ice cream, sherbet or sorbet mix prior to freezing.

When combined with water, hydrocolloids form tri-dimensional gel structures in which microscopic portions of water are trapped. If the water is mixed with other soluble or miscible compounds, such as ethyl alcohol, prior to the admixing of hydrocolloids, this soluble or miscible compound will also be trapped in the gel structure. Thus, the ethyl alcohol contained in alcoholic beverages or in mixtures of water and alcohol used in the preparation of the ethyl alcohol stabilizing mix will become trapped in the hydrocolloidal three-dimensional gel structures. Once trapped, the ethyl alcohol from the ethyl alcohol stabilizing mix will not exude from the bulk of the ice cream, sherbet or sorbet mixes during or after the freezing process. The alcoholic beverage or ethyl alcohol trapped in the tri-dimensional hydrocolloid gel structures retains its full flavor and aroma.

A possible additional effect of the trapping of ethyl alcohol in the tri-dimensional gel structure is the reduction of the interaction of the ethyl alcohol with milk proteins present in ice cream and sherbet mixes, such interaction consisting of partial denaturation of the milk proteins by the ethyl alcohol, with adverse effect on the texture of the finished frozen products.

The basic ice cream, sherbet and sorbet mix with which the ethyl alcohol stabilizing mix is admixed is based on conventional commercial mixes, with proper adjustments to compensate for the extra liquid and sweetening agents present in the ethyl alcohol stabilizing mix.

Ice creams, sherbets and sorbets prepared according to the method and composition here presented can contain substantial quantities of ethyl alcohol, without suffering changes of texture and structure caused by the separation of the ethyl alcohol upon freezing and during storage in the frozen sate.

The invention here described is useful for creating ice cream, sherbet and sorbet products with stable and homogeneous texture and structure. The homogeneity of texture and structure is durable and remains unchanged for a minimum of 6 months, thus allowing manufacturing of the products at production level scale and transportation and storage of the finished frozen products, so that the products can reach distribution channels and end users.

The achievement of the benefits described the present invention requires neither new or sophisticated manufacturing equipment nor the use of rare or expensive materials and ingredients. All the benefits of the invention can be achieved using standard equipment and ingredients available to the food industry.

The ice creams, sherbets and sorbets manufactured using this invention bring a large quantity of novel flavors to the end user and are a refreshing alternative for alcoholic drinks.

The composition consistency of the ethyl alcohol stabilizing mix and of the ice cream, sherbet and sorbet products allows adequate labeling of package, with inclusion of information about the alcohol content of the product.

Although ice creams, sherbets and sorbets are here described as the target final products of this invention, this invention can be used for the preparation of all the variations of this type of frozen food products, such as low fat ice creams and sherbets, frozen yogurts, ices, granites, softserv ice creams, gelatos and frozen mousses. This invention can also be used for manufacturing of ice cream type products with no milk products, consumed in diets with restrictions regarding milk products. The present invention can also be used for preparation of frozen alcoholic beverages.

This invention can be used for preparation of alcoholic ice creams, sherbets and sorbets flavored with alcoholic beverages or combination of alcoholic beverages manufactured by any of the conventional manufacturing methods, such as distillation, fermentation, or mixture or maceration of ethyl alcohol with flavoring agents.

The hydrocolloids used in the preparation of the ethyl alcohol stabilizing mix comprise sodium carboxymethylcellu lose, methylcellu lose, methylethylcellulose, hid roxypropylcellulose, lambda carrageenan, guar gum and gelatin. Combinations of such hydrocolloids can also be used for the preparation of the ethyl alcohol stabilizing mix.

Sodium carboxymethylcellulose, methylcellulose, methylethylcellulose and hidroxypropylcellulose are also known as cellulose gums. These hydrocolloids are easily dissolved in water ind mistures of water and ethyl alcohol. They have a high water holding capacity and form weak gels; they form stronger gels when in combination with carrageenan or guar gum.

Carrageenans are also known as Irish moss. The lambda form of carrageenan is soluble in water at low temperatures. Carrageenans form gels, the strength of which can be increased by the addition of potassium ions.

Guar gum is readily soluble in cold mixes and forms very viscous solutions. The viscosity of such solutions increases as the temperature of the mix decreases.

Gelatin has a high water holding capacity, increases the viscosity of the mix and also contributes to improve the smoothness of the mix.

All the hydrocolloids described in this invention are of current use in the food industry, are commercially available and accepted by the FDA for use in foods.

### DESCRIPTION OF PREFERRED EMBODIMENT

The method for preparation of alcoholic ice creams, sherbets and sorbets described in the present invention comprises the following steps:

1. Preparation and Processing of an Ethyl Alcohol Stabilizing Mix

The ingredients of the ethyl alcohol stabilizing mix comprise alcoholic beverages, ethyl alcohol, filtered water and hydrocolloids.

The ingredients of the ethyl alcohol stabilizing mix are first measured or weighted. The liquid ingredients comprising alcoholic beverages, ethyl alcohol and filtered water are placed in a vat and blended together to form a homogeneous solution. Powdered hydrocolloids, selected from the group consisting of sodium carboxymethylcellulose, methylcellulose, methylethylcellulose, hidroxypropylcellulose, lambda carageenan, gelatin and guar gum are slowly added to the solution in the vat under agitation, until a homogeneous hydrocolloidal sol is obtained. This sol is then chilled to about 10° C. and stored for a minimum of 4 hours. The ethyl alcohol stabilizing mix is further chilled to 0-2° C. before being admixed with the basic ice cream, sherbet and sorbet mix.

2. Preparation and Processing of a Basic Ice Cream, Sherbet or Sorbet Mix

The basic ice cream, sherbet and sorbet mixes described in this method contain ingredients typically used for the preparation of this type of frozen food products, such as dairy products (milk solids, milk fat and cream), eggs, fruit juices or concentrates, sweeteners (sugar, corn syrup), stabilizers and emulsifiers.

Conventional commercial ice cream, sherbet and sorbet product mixes are suitable for use with the method presented in this invention, provided that the quantities of liquids and sweeteners are adjusted for the additional quantities of such ingredients that will be admixed with the ethyl alcohol stabilizing mix.

The ingredients of the basic ice cream, sherbet and sorbet mixes are measured or weighted and combined in a vat under agitation and heating, following conventional manufacturing methods for this type of products.

Once all the ingredients are homogeneously combined, the ice cream and sherbet basic mixes undergo pasteurization and homogenization processes, after which the mixes are chilled to a temperature between 0-2° C.

In the case of sorbets, pasteurization and homogenization are optional and the mix can be directly brought to a temperature between 0-2° C.

3. Admixing the Ethyl Alcohol Stabilizing Mix With the Basic Ice Cream, Sherbet or Sorbet Mix

The chilled ethyl alcohol stabilizing mix is added to the chilled basic ice cream, sherbet or sorbet mix and the resulting mix is blended until it becomes a homogeneous final mix.

4. Freezing the Resulting Alcoholic Ice Cream, Sherbet and Sorbet Mix

The final mix is transferred to an ice cream freezer and immediately frozen.

5. Filling Packages in Which the Products Will be Commercialized

The frozen final mix is then place into the containers in which it is going to be commercialized and hardened. It is now ready to be stored, transported or commercialized.

### Example 1

### An Ice Cream Flavored with Orange Liqueur

a) Preparation of the Ethyl Alcohol Stabilizing Mix

| | | |
|---|---|---|
| Water | 35.0 | lb |
| Orange liqueur, 40% alcohol by volume | 60.0 | lb |
| Methylcellulose | 2.0 | lb |

The orange liqueur and water are placed in a vat equipped with agitation. The methylcellulose is dispersed in the mix under agitation. Agitation is continued for at least 4 hours or until the mix is completely homogenous. The mix is chilled to approximately 10° C. and stored for 4 hours. The mix is chilled to 0-2° C. before being admixed with the basic ice cream mix, prepared in part b) of this example.

b) Preparation of the Basic Ice Cream Mix

| | | |
|---|---|---|
| Commercial stabilizer mix | 2.5 | lb |
| Dried egg yolk | 2.4 | lb |
| Sugar | 63.0 | lb |
| Cream (30% fat) | 145.0 | lb |
| Nonfat dried milk solids | 42.0 | lb |
| Water | 95.0 | lb |

This basic ice cream mix is processed following standard manufacturing procedures for this type of frozen food products. The ingredients are placed in a vat equipped with agitation and heating. The mix is heated under agitation until it becomes homogeneous. The mix is then pasteurized, homogenized and cooled to 2° C.

c) Preparation of the Final Ice Cream Mix

The chilled ethyl alcohol stabilizing mix prepared in item a) is admixed with the basic ice cream mix prepared in item b) and blended to form a homogeneous final ice cream mix. The final ice cream mix is pumped into an ice cream freezer and frozen under agitation. The resulting frozen ice cream is pumped into the final containers and hardened. The concentration of orange liqueur in the finished product is 13.4%, corresponding to approximately 5.3% of ethyl alcohol.

### Example 2

### A wine flavored sorbet

a) Preparation of Ethyl Alcohol Stabilizing Mix

| | | |
|---|---|---|
| Wine | 38.00 | lb |
| Water | 2.00 | lb |
| Guar gum | 0.20 | lb |
| Carboxymethylcellulose | 0.30 | lb |

The wine is placed in a vat equipped with an agitation device. The carboxymethylcellulose and guar gum are dispersed in the wine under agitation. Agitation is continued for at least 4 hours or until the ethyl alcohol mix is completely homogeneous. The mix is chilled to 10° C. and stored for 24 hours. This ethyl alcohol stabilizing mix will be further chilled to 0-2° C. before being admixed with the basic sorbet mix prepared in item b) of this example.

b) Preparation of the Basic Sorbet Mix

| | | |
|---|---|---|
| Water | 30.80 | lb |
| Sugar | 25.00 | lb |
| Maltrodextrin DE | 3.00 | lb |
| Cellulose gel | 0.50 | lb |
| Locust bean gum | 0.06 | lb |
| CMC | 0.05 | lb |
| Mono and diglycerides | 0.03 | lb |
| Xanthan gum | 0.02 | lb |
| Carrageenan | 0.02 | lb |
| Polysorbate 80 | 0.01 | lb |

This basic sorbet mix is processed following standard manufacturing procedures for this type of frozen food products. The ingredients are placed in a vat equipped with agitation and heating. The mix is heated under agitation until it becomes homogeneous. The mix is cooled to 2° C.

c) Preparation of the Final Sorbet Mix

The chilled ethyl alcohol stabilizing mix prepared in item a) is admixed with the basic sorbet mix prepared in item b) and blended to form a homogeneous final sorbet mix. The final sorbet mix is pumped into an ice cream freezer and frozen under agitation. The resulting frozen sorbet is pumped into the final containers and hardened.

The wine concentration in the finished frozen food product is approximately 38% of wine, corresponding to approximately 3% to 6% of ethyl alcohol, depending on the type of wine that is used.

1. A method for preparing an ice cream type product containing 0.5-40% of ethyl alcohol by weight, comprising the steps of:
a) preparing a basic ice cream type mix,
b) preparing an ethyl alcohol stabilizing mix for preservation of homogeneity of texture and structure of said ice cream type product after freezing and during storage in the frozen state,
c) admixing said ethyl alcohol stabilizing mix with said basic ice cream type mix to form a final ice cream type mix, and
d) freezing said final ice cream type mix to form said ice cream type product, whereby said ice cream type product will contain 0.5-40% of said ethyl alcohol by weight and have a homogeneous and stable structure and texture after freezing and during storage in a frozen state.

2. The method from claim 1 wherein said ice cream type product is selected from the group consisting of ice creams, sherbets and sorbets.

3. The method from claim 1 wherein said ethyl alcohol stabilizing mix contains 0.5-95% of ethyl alcohol by weight.

4. The method from claim 1 wherein the preparation of said ethyl alcohol stabilizing mix comprises the steps of:
a) preparing a solution of ethyl alcohol by mixing water with a material selected from the group consisting of ethyl alcohol and alcoholic beverages,
b) dissolving hydrocolloids in said solution of ethyl alcohol to form said ethyl alcohol stabilizing mix,
c) chilling said ethyl alcohol stabilizing mix to about 10° C.,
d) storing said ethyl alcohol stabilizing mix at 10° C. from 4 hours to several hours, and
e) chilling said ethyl alcohol stabilizing mix to 0-2° C. prior to admixing said ethyl alcohol stabilizing mix with said basic ice cream type mix to form said final ice cream type mix
whereby said final ice cream type mix will contain 0.5-40% of ethyl alcohol by weight and have stable and homogeneous texture and structure after freezing and during storage in a frozen state.

5. The method from claim 4 wherein said hydrocolloids are selected from a group consisting of sodium carboxymethylcellulose, methylcellulose, methylethylcellulose, hydroxypropylcellulose, hydroxypropylmethyl cellulose, lambda carageenan, gelatin and guar gum.

6. The method from claim 1 wherein said basic ice cream type mix contains ingredients typically used in manufacturing of conventional ice cream type products, selected from a group consisting of milk solids, milk fat, cream, eggs, fruit juices, fruit concentrates, sweeteners, stabilizers and emulsifiers.

7. The method from claim 1 wherein said basic ice cream type mix is prepared and processed following conventional methods of preparation and processing of this type of mix.

8. A method for preparing an ice cream type product containing 0.5-40% of ethyl alcohol by weight, in which said ethyl alcohol is admixed with other ingredients of said ice cream type product in the form of an ethyl alcohol stabilizing mix, said ethyl alcohol stabilizing mix containing 0.5-95% of ethyl alcohol by weight.

9. The method from claim 8 wherein said ice cream type product is selected from the group consisting of ice creams, sherbets and sorbets.

10. A method for preparing an ethyl alcohol stabilizing mix containing 0-95% of ethyl alcohol by weight, in preparation for the admixture therewith of a basic ice cream type mix to form a final ice cream type mix and subsequent freezing of said final ice cream type mix to form an ice cream type product containing 0.5-40% of ethyl alcohol by weight, with stable and homogeneous texture and structure after freezing and during storage, and no separation of ethyl alcohol from the mass of said ice cream type product, comprising the steps of:
a) preparing a solution of ethyl alcohol by mixing water with a material selected from the group consisting of ethyl alcohol and alcoholic beverages,
b) dissolving hydrocolloids in said solution of ethyl alcohol to form an ethyl alcohol stabilizing mix,
c) chilling said ethyl alcohol stabilizing mix to about 10° C.,
d) storing said ethyl alcohol stabilizing mix at 10° C. from 4 hours to several hours, and
e) chilling said ethyl alcohol stabilizing mix to 0-2° C. prior to admixing said ethyl alcohol stabilizing mix with said basic ice cream type mix to form said final ice cream type mix,
whereby said final ice cream type mix will contain 0.5-40% of ethyl alcohol by weight, and have stable and homogeneous texture and structure after freezing and during storage, and no separation of the ethyl alcohol from the mass of said ice cream type product.

11. The method from claim 10 wherein said ice cream type product is selected from the group consisting of ice creams, sherbets and sorbets.

12. The method from claim 10 wherein said hydrocolloids are selected from a group consisting of sodium carboxymethylcellulose, methylcellulose, methylethylcellulose, hydroxypropylcellulose, hydroxypropylmethyl cellulose, lambda carageenan, gelatin and guar gum.

13. The method from claim 10 wherein said basic ice cream type mix contains ingredients typically used in manufacturing of ice cream type products, selected from a group consisting of milk solids, milk fat, cream, eggs, fruit juices, fruit concentrates, sweeteners, stabilizers and emulsifiers.

14. The method from claim 10 wherein said basic ice cream type mix is prepared and processed following conventional methods of preparation and processing of this type of mix.
